(19) United States
(12) Patent Application Publication
(10) Pub. No.: US 2014/0130938 A1
(43) Pub. Date: May 15, 2014

(54) NATURAL GAS HOME FAST FILL REFUELING STATION

(71) Applicant: Michael J. Luparello, Lakewood, CA (US)

(72) Inventor: Michael J. Luparello, Lakewood, CA (US)

(21) Appl. No.: 13/677,560

(22) Filed: Nov. 15, 2012

(51) Int. Cl. F17C 5/06

(52) U.S. Cl. CPC F17C 5/06
USPC 141/69

(57) ABSTRACT

A home based fast-fill natural gas refueling station for providing natural gas fuel to a vehicle. A compressor is attached to the natural gas fill line. The compressor functions to pressurize a natural gas storage tank array. The storage tank array includes a plurality of natural gas storage tanks. A pressurized natural gas storage tank exit line is connected to a frontmost storage tank and a fill nozzle is connected to the storage tank exit line. During the refueling process the compressor is turned off. Also, during the refueling process as the pressure is depleted in the frontmost storage tank the frontmost storage tank is simultaneously and rapidly repressurized by other storage tanks in the storage tank array allowing for fast refueling of the vehicle.

This application claims the benefit of Provisional Application 61/570,178 filed Dec. 13, 2011, which is incorporated by reference herein. The present invention relates to refueling stations, and in particular, to natural gas refueling stations.

### BACKGROUND OF THE INVENTION

There are many reasons why natural gas makes an excellent automobile fuel. There is an abundance of natural gas available right here in the United States of America. Some say we have 500 years of it, and that means we can be supporting our own country for centuries instead of buying foreign oil from our enemies. Natural gas is also cleaner burning than gasoline or diesel. It's even more environmentally “green” than an electric vehicle, because half of the nation's electricity is generated by burning coal. Also, a natural gas car can be easily and quickly refilled at a filling station while an electric car would take hours to recharge. Natural gas is also a much less expensive fuel than gasoline. Finally, natural gas is safer than gasoline because if a fuel spill occurs, the fuel is a low-density gas that will float up and away instead of pooling on the ground, much safer in case of a fire.

There are currently two types of natural gas filling stations. Public gas stations located away from the drivers' homes are “fast fill” stations, where a car tank can be filled in a few minutes, similar to the time it takes to fill the gasoline tank of a conventional car. These commercial fast fill stations have large noisy compressors and large storage tanks, and they are few and far between. Currently the natural gas home filling stations available utilize a slow compressor directly filling the car tank and can take many hours to fill the car. As a consequence, most home owners who utilize this “slow fill” method will fill their cars up overnight while hoping that the compressor noise does not interfere with their sleep or their neighbors sleep.

K bottles are known. A K bottle is a bottle of compressed gas. The below table shows the specifications for a K bottle:

| | | | | Internal Volume | | |
|---|---|---|---|---|---|---|
| | | | | Nominal @ | | |
| | Nominal | Nominal | Water | 70° F., 1 ATM | | |
| | Dimensions¹ | Tare Weight | Capacity | | Cubic | DOT |
| Cylinder Size | Dia × Lgth, in | lbs. | lbs. | Liters | Feet | Specifications |
| K | 9¼ × 60 | 135 | 110 | 49.9 | 1.76 | 3AA2400 |

What is needed is a better home based natural gas refueling station.

### SUMMARY OF THE INVENTION

The present invention provides a home based fast-fill natural gas refueling station for providing natural gas fuel to a vehicle. A compressor is attached to the natural gas fill line. The compressor functions to pressurize a natural gas storage tank array. The storage tank array includes a plurality of natural gas storage tanks. A pressurized natural gas storage tank exit line is connected to a frontmost storage tank and a fill nozzle is connected to the storage tank exit line. During the refueling process the compressor is turned off. Also, during the refueling process as the pressure is depleted in the frontmost storage tank the frontmost storage tank is simultaneously and rapidly repressurized by other storage tanks in the storage tank array allowing for fast refueling of the vehicle.

### BRIEF DESCRIPTION OF THE DRAWINGS

FIG. 1 shows a preferred embodiment of the present invention.

### DETAILED DESCRIPTION OF THE PREFERRED EMBODIMENTS

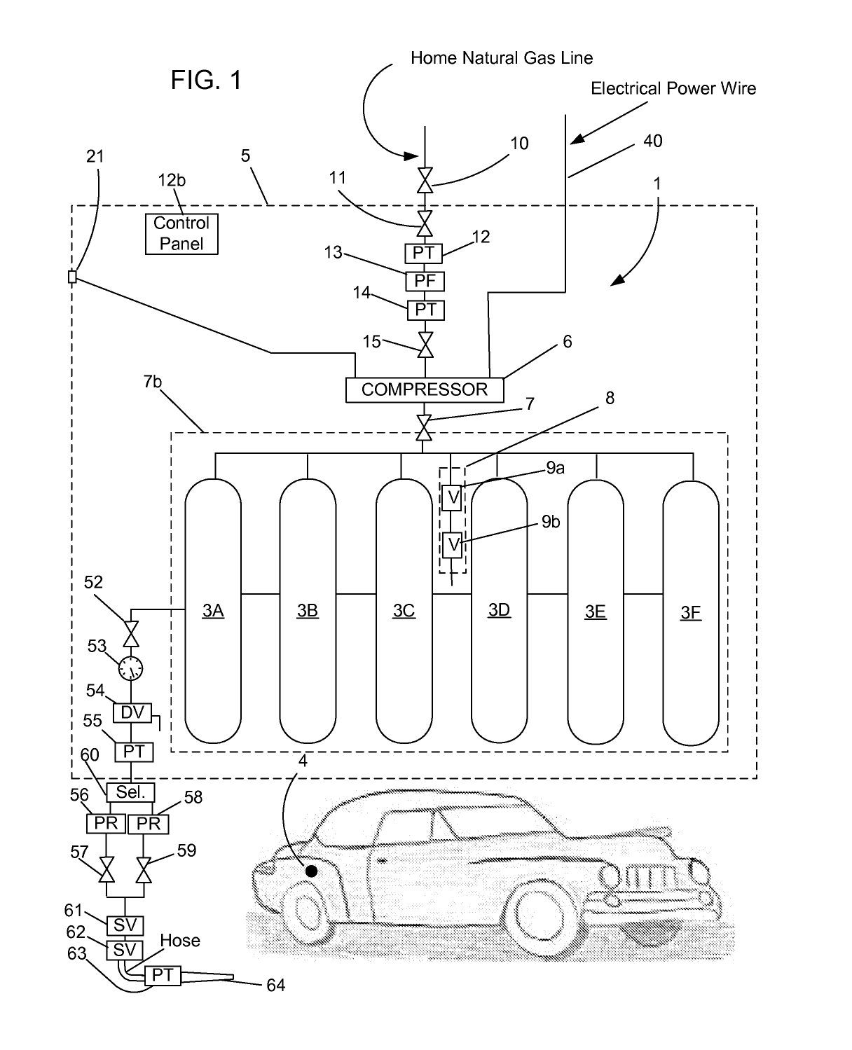

Home based fast-fill station 1 (FIG. 1) is a self-contained compressed natural gas (CNG) filling station for rapidly refilling a natural gas powered vehicle. The unit preferably includes an automatic multi-stage compressor, a storage tank and a fill nozzle, along with other control and safety components.

In a preferred embodiment, the home natural gas line connects to manual shutoff valve 10. Manual shutoff valve 10 is followed by earthquake valve 11 to shut off the gas in the event of a strong earthquake. Pressure transducer 12 functions to send source pressure information to the control panel 12b. Particulate filter 13 functions to trap small particles that might interfere with the proper function of check valves, pressure relief valves, pressure regulators and the compressor. Pressure transducer 14 detects excessive pressure drop across the filter 13 if it is clogged. Pressure relief valve 15 is preferably set slightly above the supply pressure to protect the house against overpressure from backflow leakage and protect compressor 6 from excessive supply pressure. Multi-stage compressor 6 is capable of compressing natural gas from atmospheric pressure to at least 4500 psi. Check valve 7 prevents back flow from storage tank array 7b back through compressor 6 into the house.

Water trap 8 keeps excessive moisture from storage tank array 7b. Preferably water trap 8 empties automatically. Water trap 8 preferably is a low spot in the piping with a T intersection and a section of vertical pipe below connected to the branch of the T. If any water condenses during the compression of the natural gas, it will collect in this vertical drainpipe below the T intersection. The vertical pipe includes two solenoid valves 9a and 9b next to each other in series. During the start of the process of dispensing gas into the car, the control system will open the upper solenoid valve 9a, then close it, then open the lower solenoid valve 9b and then close it. A small amount of high pressure gas along with any water in the water trap will be automatically ejected out the bottom of the vertical pipe by this procedure. These solenoids are wired into the same control system that operates the two nozzle solenoids 61 and 62 (see discussion below). When nozzle solenoid valve 61 is energized to open and then shut, water trap solenoid valve 9a will also open an shut, and when nozzle solenoid valve 62 is energized to open and shut, water trap solenoid valve 9b will also open and shut. When the second switch on the control panel is turned on to dispense gas (open nozzle solenoid valves 61 and 62 simultaneously), water trap solenoid valves 9a and 9b will be disabled to keep them from opening.

Storage tank array 7b preferably includes several large steel tanks (3A-3F) similar to welding gas tanks. Pressure relief valve 52 set at about 5000 psi to protect the steel tanks (3A-3F) from exploding if the compressor malfunctions and stays on. Pressure gage 53 shows the pressure out of storage tank array 7b. Manual drain valve 54 is connected to an exhaust vent tube. Pressure transducer 55 senses the pressure in the storage tank array 7b and sends the information to control panel 12b to automatically turn the compressor on and off to maintain the desired storage tank pressure. Next we have a T fitting branching into two short parallel pipes. The left path preferably includes a 3000 psi pressure regulator 56 and pressure relief valve 57 set a few hundred psi above the regulator pressure at about 3400 psi. The right hand path preferably includes a 3600 psi pressure regulator 58 and a pressure relief valve 59 set 400 psi above at about 4000 psi. The left hand path is for vehicles to be filled to 3000 psi and the right hand path is for vehicles that can be filled to 3600 psi. These two paths connect to a switching valve called the nozzle pressure selector 60 which allows the operator to choose which pressure to use to fill the vehicle. Most new CNG vehicles have a maximum system pressure of 3600 psi but some older CNG vehicles are not designed to be pressurized above 3000 psi. For both of these paths, the pressure regulator reduces the high pressure from the storage tank down to the correct pressure for the vehicle. The pressure relief valves are to protect the vehicle from excessive pressure if the pressure regulator malfunctioned.

Electrically actuated solenoid valves 61 and 62 are used together to test the seal between the fill nozzle and the vehicle. The first valve 61 opens and closes to let a small amount of gas into the volume between the two valves. Then the second valve 62 opens to let this gas expand into the fill nozzle hose and up to the vehicle pressurizing the hose with a small amount of gas. If the gas remains for several seconds at the same pressure, this will indicate to the control panel that the nozzle has a sealed attachment to the vehicle and it is therefore safe to start filling the vehicle tank. The next component is another pressure transducer 63 which is used to detect the pressure in the fill nozzle during the safety seal check just mentioned, and also to indicate the pressure in the car tank when the fill operation is complete. The last component is the fill nozzle 64. This is the nozzle that attaches to and seals to the vehicle.

### Normal Operation of the System

Preferably, a user attaches the fill nozzle 64 to the vehicle fill tube. Then the user flips a first electrical switch on control panel 12b. This disables the compressor and initiates the test procedure to make sure the fill nozzle is connected to the vehicle. The control panel 12b sequentially opens first nozzle solenoid valve 61, closes it, and then opens second nozzle solenoid valve 62. This procedure dispenses a small but significant amount of CNG into the fill hose and nozzle at about 100 psi. Under normal conditions, there will be an adequate seal and connection between the nozzle and the vehicle so that this test pressure in the nozzle will remain steady. The control system will check this for several seconds using the signal from pressure transducer 63. If the pressure holds steady, this means that there is a car connected to the nozzle and it is safe to dispense gas. The user can also verify this because the pressure readout from pressure transducer 63 will be visible on the control panel.

When the user is satisfied that the pressure is normal and holding, he flips a second switch or button on the control panel that will start the fill sequence by opening both solenoid valves 61 and 62 simultaneously. This will start a very rapid flow of CNG into the vehicle tank. The flow takes place because storage tank 7b pressure and the pressure regulator 56 or 58 is higher than the vehicle tank pressure. Flow will continue until one of two conditions is met. For a small or medium sized vehicle tank or partially filled vehicle tank, flow will continue until the vehicle tank pressure is full, that is the vehicle tank pressure is equal to the pressure of either pressure regulator 56 or 58. For a large vehicle tank or if the vehicle is being filled from a partially filled storage tank array 7b, the flow will continue with the vehicle tank pressure increasing and storage tank array 7b pressure decreasing until both pressures are the same. Because the gas is flowing under its own pressure without being pumped, the fill time does not depend on the speed of a compressor or pump and the entire fill process will be just as fast as at a public filling station. The operator can see the gas pressure readout on the control panel at the end of the fill process to see how full the vehicle tank is. At the conclusion of the fill process, the operator turns off the switches on the control panel to close solenoid valves 61 and 62. Then the nozzle is removed from the car and the process is complete. During this process, as soon as the gas started flowing and storage tank 7b started reducing in pressure, compressor 6 will want to start pumping. As a safety precaution, the control panel will not allow the compressor to run while the vehicle tank is being filled. At the conclusion of the fill process when the solenoid valves 61 and 62 are closed, the compressor will start and will continue to run until the pressure in the storage tank array 7b is once again at 4500 psi.

In a preferred embodiment, as a safety precaution, if the user turns on the second “fill” switch on the control panel without first turning on the first “test” switch, the fill solenoid valves 61 and 62 will not open.

### Preferred Components of the Home Fast Filling Station

### Manual Gas Shutoff Valve

Manual gas shut off valve 10 is part of the gas line installed from the home. Home gas lines typically include shutoff valve installed at their end.

### Earthquake Valve

Earthquake valve 11 is set to shut off the gas supply if there is any significant seismic activity. The device senses acceleration and closes isolating the filling station from the house gas supply. Preferably, it is also shuts off the gas in the event of an explosion or if the filling station gets hit by a car.

### Pressure Transducer

Pressure transducer 12 measures the supply pressure at the upstream side of the filter 13. When compared to the downstream pressure, this will indicate to the control system when the filter needs to be replaced or if manual valve 10 or earthquake valve 11 is shut off.

### Particulate Filter

Particulate filter 13 is a particle filter designed to trap particles and prevent them from getting into the other components. A spec of rust or other contamination from the gas supply pipe could otherwise possibly interfere with the operation of the one-way check valves, pressure regulators, pressure relief valves, or other sensitive components, and might cause premature wear of compressor components. This filter is upstream of any components with moving parts to protect them from contamination. Also filters are larger diameter than most of the other components which makes it harder to make them strong enough to withstand high pressures. By locating the filter here, a less expensive filter can be used that does not have to withstand high pressure.

### Pressure Transducer

Pressure transducer 14 senses the pressure down-stream of the filter 13. The purpose is to detect any large pressure drop across the filter. If the filter gets clogged with contamination, the compressor will have a harder time sucking natural gas through the filter and this will lead to a pressure drop down-stream of the filter. If this happens, pressure transducer 14 will detect it and preferably will make a light turn on at control panel 12b indicating that the filter needs to be changed. This would also detect a closed manual shutoff valve or closed earthquake valve.

### Pressure Relief Valve

Pressure relief valve 15 is preferably set at about 10 psi gage pressure (25 psi absolute). The inlet gas pressure from the house should never get above about 5 psi gage pressure so this pressure relief valve will normally never open. If pressure leaks backwards from the storage tanks through the compressor and the one-way check valve, then pressure relief valve 15 prevents the pressure from going back into the house, over pressurizing some natural gas appliance (like a furnace, water heater, stove, oven, drier, etc.) and possibly causing a fire or explosion in the house.

Pressure relief valve 15 also protects the filling station in the event that it is attached to a higher pressure commercial natural gas supply line. The compressor is designed to work with a low pressure house natural gas supply. Excessive inlet pressure will subject the beginning stages of the compressor to too much gas pressure and may cause compressor damage. The product directions will preferably state the limitation of the maximum allowable inlet pressure but in the event that limitation is ignored, this pressure relief valve will vent the excess pressure as soon as the gas manual valve is turned on and will be impossible to ignore.

### Compressor

Compressor 6 is preferably a 3 or 4 stage compressor that pumps the natural gas from an initial pressure of about 15 psia (absolute pressure of 15 psi, gage pressure of 0.25 psi) to a final pressure of 4500 psi. This compressor can be relatively small but preferably is able to pump at the rate of at least 0.5 gallons per hour. The compressor will run to refill storage tanks 3A-3F after the car tank has been filled.

### Check Valve

Check Valve 7 is a one way valve that prevents gas from going from the tanks backwards through the compressor and back into the house. This is such a crucial device and relatively inexpensive, so that in a preferred embodiment two are connected in series for redundancy and safety.

### Water Trap with Automatic Empty Feature

In a preferred embodiment, water trap 8 is located at a low spot in the piping with a T intersection and a section of vertical pipe below connected to the branch of the T. If any water condenses during the compression of the natural gas, it will collect in this vertical drain pipe below the T. The vertical pipe will have two solenoid valves next to each other in a series gas connection. During the start of the process of dispensing gas into the car, upper solenoid valve 9a will open, then close, then lower solenoid valve 9b will also open and close. A small amount of high pressure gas along with any water in the system will be automatically ejected out the bottom of the vertical pipe by this procedure.

### Water Trap Upper Solenoid Valve and Lower Solenoid Valve

Water trap solenoid valves 9a and 9b are two electrically operated (on-off) valves that are placed next to each other on the low end of water trap 8. By opening and closing upper valve 9a and then opening and closing the lower valve 9b any water caught in the trap will be ejected from the system by a small amount of high pressure CNG.

### Storage Tanks

Storage tanks 3A-3F are large steel tanks (similar to welding gas tanks) attached together act as a single large tank 7b. These tanks will be used up to a maximum pressure of 4500 psi. The total volume of the tanks are preferably approximately three times the size of the typical vehicle storage tank so that during the filling of an empty vehicle, the tank pressure will only drop from 4500 psi to about 3375 psi. For the filling of a vehicle that would be normally not quite empty, the storage tank will have enough pressure to completely fill the vehicle tank to 3600 psi.

In a preferred embodiment tanks 3A-3F are each a 4500 psi K bottle. For example, during refueling, the gas quickly flows from the higher pressure storage tank 3A into car tank 4 allowing rapid refueling. As natural gas leaves tank 3A it is immediately replenished by pressurized gas in tanks 3A-3F. After refueling, compressor 2 will run for a few hours to re-pressurize storage tanks 3A-3F. The compressor and storage tanks are preferably housed in small weatherproof locking shed 5 that will typically be installed by the homeowner along one edge of the driveway.

### Pressure Relief Valve

Pressure relief valve 52 will be set at about 5000 psi and will protect the tank from exploding if the compressor shut-off circuit stops working and the compressor runs continuously.

### Pressure Gage

Pressure gage 53 shows the pressure in the storage tanks. The gauge should have a capacity of 6000 psi and will nominally read up to 4500 psi.

### Manual Drain Valve

Drain valve 54 is located at the output of the storage tanks. Preferably drain valve 54 is attached to a T fitting and includes an exhaust vent pipe. Drain valve 54 is utilized if maintenance needs to be performed on the system. The natural gas supply may need to be turned off and the system may need to be drained through this manual drain.

### Pressure Transducer

This pressure transducer 55 will sense the pressure in the tanks and will turn on compressor 6 when the tanks 3A-3F need more pressure. It will shut off compressor 6 when the tanks have 4500 psi.

### Pressure Selector Switch

Pressure selector switch 60 is a switch that allows the user to select between 3000 psi and 3600 psi. Most newer CNG vehicles operated at a maximum rated pressure of 3600 psi but there are some older vehicles that run on 3000 psi.

### 3000 PSI Pressure Regulator and 3600 PSI Pressure Regulator

3000 PSI pressure regulator 56 and 3600 PSI pressure regulator 58 are preferably set at 3000 psi and 3600 PSI and are preferably in two parallel pipes. They both function to control the output pressure of the filling station to never be more than the car can withstand, so that the car is not over pressurized. The two pressure regulators are in parallel with selector switch 60 so that the user can switch between 3000 or 3600 psi gas pressure regulation depending upon the needs of the particular car being filled.

### Pressure Relief Valves

Pressure relief valves 57 and 59 are preferably set at about 3400 psi (for the 3000 psi regulator) and 4000 psi (for the 3600 psi regulator) to guard against putting too much pressure into the car if the pressure regulator fails. A pressure regulator must be set to some pressure a little above the working pressure because they may start to leak a little near their set pressure.

It should be noted that in another preferred embodiment pressure relief valves 57 and 59 could be eliminated. In another embodiment, these components would not be necessary because even if the storage tanks were completely full they would only have 4500 psi. A car being refueled is capable of four times the working pressure of 3600 psi without having a rupture and the proof test is 1.5 times the working pressure. So the car proof pressure is 4500 psi and the car burst pressure is at least 14,400 psi. Since a failure of the regulator would only affect the filling of the car, it only becomes an issue at the last stage of the car refilling, where the storage tank pressure would not be much in excess of the 3600 psi and certainly much less than the 4500 psi original storage tank pressure. Therefore, in another embodiment pressure relief valves 57 and 59 could be eliminated and still be very safe.

### First Nozzle Solenoid Valve

First nozzle solenoid valve 61 and second nozzle solenoid valve 62 are positioned in series right next to each other. They are located prior to the fill nozzle hose. The two solenoids and pressure transducer 63 function to check to see if the fill nozzle is correctly attached to the car so that there are no leaks. When a “test” button on control panel 12b is pushed, the upstream valve 61 opens to allow a small amount of 4500 psi gas to flow into the area between the valves. Then it closes. Then the downstream valve 62 opens to let this 4500 psi gas expand into the fill hose and nozzle to pressurize them to about 100 psi. Pressure transducer 63 monitors this pressure for a few seconds to make sure there are no leaks, and if the pressure stays constant for a few seconds then the control system lights up a second “fill” button on the control panel and enables the flow of high pressure gas into the car as soon as the fill button is pushed.

### Second Nozzle Solenoid Valve

Second nozzle solenoid valve 62 works with first solenoid valve 61 to send a metered amount of test gas into the nozzle to test that the dispensing nozzle is sealed to the car fill tube. This must be verified before the control panel allows the fill process to take place. Otherwise there is a risk of spillage of a very large quantity of CNG and the possible high speed motion of the nozzle if it is not connected to the car.

### Pressure Transducer

Pressure transducer 23 is positioned on the fill hose and sends an electrical signal to control panel 12b indicating the pressure in the fill hose. While fill nozzle 64 is connected to the car, this digital readout of the fill hose will indicate the pressure inside the car's tank, and it will be accurate near the end of the fill process when the gas flow rate reduces and eventually stops.

### Fill Nozzle

Fill nozzle 64 is a commercially available fill nozzle from a supplier of CNG products.

### Shed

Shed 5 preferably will be large enough to house the storage tank (no more than a 6-pack of “K” bottles—welding tank size) and compressor 2 with sound proofing. Shed 5 preferably has a door that locks similar to a front door lock. Shed 5 will be preferably weather proof. Gas line 10 and electrical power wiring 40 for compressor 2 from the house will normally be brought to shed 5 underground and will come up through the floor of the shed so that all the gas and electrical connections are protected from the weather and hidden from view to minimize vandalism and improve aesthetics. Shed 5 is preferably fastened to the ground to prevent tip-over or theft and the shed will hold storage bottles 3A-3F to prevent them from falling. If necessary, a gas meter will be included in the shed. Preferably the approximate minimum size is 2 feet wide by 4 feet long and 5 feet high.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

What is claimed is:

1. A home based fast-fill natural gas refueling station for providing natural gas fuel to a vehicle, comprising:
A. a natural gas fill line connected to said home,
B. a compressor connected to said natural gas fill line,
C. a natural gas storage tank array, said storage tank array comprising a plurality of natural gas storage tanks, said plurality of natural gas storage tanks further comprising a frontmost storage tank,
D. a pressurized natural gas storage tank exit line connected to said frontmost storage tank,
E. a fill nozzle connected to said exit line,
wherein as pressurized natural gas is depleted from said frontmost storage tank during fueling of a vehicle, said frontmost storage tank is simultaneously repressurized via other storage tanks is said natural gas storage tank array.

2. The natural gas refueling station as in claim 1, wherein said compressor is shut off during the refueling process.

3. The natural gas refueling station as in claim 1, wherein said plurality of natural gas storage tanks are connected in series.

4. The natural gas refueling station as in claim 1, wherein said plurality of natural gas storage tanks are connected in parallel.

5. The natural gas refueling station as in claim 1, wherein said plurality of natural gas storage tanks are connected in series and connected in parallel.

6. The natural gas refueling station as in claim 1, further comprising a water trap connected to said storage tank array to remove water from said storage tank array.

7. The natural gas refueling station as in claim 1, further comprising a selector switch allowing a user to select a desired pressure level in which to refuel the vehicle.

8. The natural gas refueling station as in claim 7, wherein the user is able to select between 3000 psi and 3600 psi.
